(19) United States
(12) Patent Application Publication
(10) Pub. No.: US 2022/0015580 A1
(43) Pub. Date: Jan. 20, 2022

(54) VEGETABLE AND FRUIT WASHING APPARATUS

(71) Applicant: Maxine PERKINS, Shelby, AL (US)

(72) Inventor: Maxine PERKINS, Shelby, AL (US)

(21) Appl. No.: 16/932,314

(22) Filed: Jul. 17, 2020

(51) Int. Cl. A47J 43/24

(52) U.S. Cl. CPC A47J 43/24

(57) ABSTRACT

A vegetable and fruit washing apparatus which includes a dual lid system configured to couple with a cylindrical container, the dual lid comprising a first lid that is a cover containing a rectangular slot and the second lid is a strainer, wherein the first lid coupled to the second lid covers the second lid when both are closed, and the second lid includes a plurality of holes, coupled to a cylindrical container with an opening configured to allow fruit or vegetables to enter the container.

### BACKGROUND OF INVENTION

Right now, there is nothing on the market designed to wash fruits and vegetables while a person is on the go, be it at the park, hiking, camping, the softball field, or in the grocery store parking lot. Mothers with children, and other health conscious people are left trying to wash their produce in their hands. Some take a bottle of water and pour it over their produce, dropping some to the ground. Some try to use vegetable wipes on porous fruits and vegetables, like strawberries and broccoli bites, but the wipes are not able to clean the cracks and crevices where bacteria and food borne viruses hide. Some people use vegetable sprays, but that leaves their hands wet and that requires lots of paper towels. They then try to find a way to rinse the vegetable spray off. Theses sprays are just too messy! Other people are left to wash them in dirty, un-sanitized public bathroom sinks. Worst of all when surveyed most women said they wipe their fruits and vegetables on their shirts and most men said they do not wipe or wash them at all when they are out and about.

### SUMMARY OF INVENTION

The Vegetable and Fruit Washing Apparatus of the present invention gives consumers the ability to wash their fruits and vegetables on the go. The Apparatus includes a container which has a dual lid system. The top outer lid seals and locks the container. The apparatus also includes a special designed slot on the top that can hold a specialty designed veggie/fruit rinse packet. The under lid is a strainer lid. This strainer lid is called an MP Strainer Lid because it has maximum potential for withstanding vigorous shaking and liquid release.

This invention works by unscrewing the dual lid system from the top of the container, then placing the fruits or vegetables inside the container. Examples of items that can be placed inside the container include, grapes, cherries, strawberries, blueberries, plums, mini carrots, broccoli bites, etc. After placing the fruits or vegetables in the container, water and a veggie/fruit rinse powder packet is then added. The user can also use water alone. The user screws the dual lid system onto the top of the container, and then shakes the container or tilts it from side to side to allow the liquid to wash the fruits or vegetables. The user then opens the top outer lid, leaving the strainer lid in place.

Then the user pours the liquid out of the container through the strainer lid. The unique strainer lid feature stops the user from losing or spilling any freshly washed produce. The Vegetable and Fruit Washing Apparatus fits inside a standard car cup holder, so that the consumer can always keep it handy. It also has cup measurements in braille to assist the visually impaired. This product will help to remove viruses, bacteria, dirt, dust and other harmful pollutants. Consumers can buy unhealthy fast food on the go. But now there is a healthy alternative, fresh washed fruits and vegetables on the go.

### BRIEF DESCRIPTION OF THE DRAWINGS

FIG. 1 is a diagram showing the Vegetable and Fruit Washing Apparatus including dual lid system having a top lid with a slot and a second lid with a strainer;

FIG. 2 is a diagram showing the strainer lid of the dual lid system;

FIG. 3 is a diagram showing a container used to hold liquids and produce.

### DETAILED DESCRIPTION

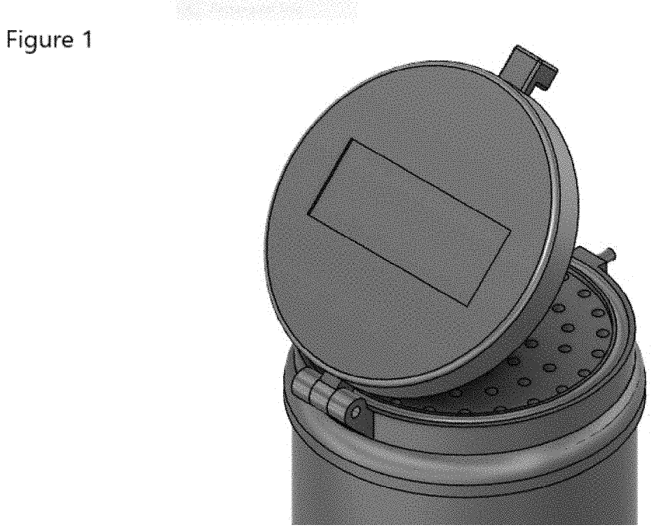

FIG. 1 is a diagram showing Vegetable and Fruit Washing Apparatus including a dual lid system attached to a cup. The dual lid system contains a top lid that contains a slot. The slot is located in the center of the top of the lid. The purpose of the slot is to hold the cleaning packet solution that is used for washing the produce placed in the cup. The top lid is attached to the strainer lid with a hinge located at the rear of the lids and locked in place with a fastener located in the front of the top lid and the strainer lid. After produce, liquid, and/or the cleaning solution are added to the container, and the dual lid system is screwed on to the top of the container. The top lid is closed over the strainer lid to prevent liquid from escaping the container when the produce is washed. After washing the produce, the top lid is opened, then the liquid and cleaning solution if used are strained from the container through the strainer lid.

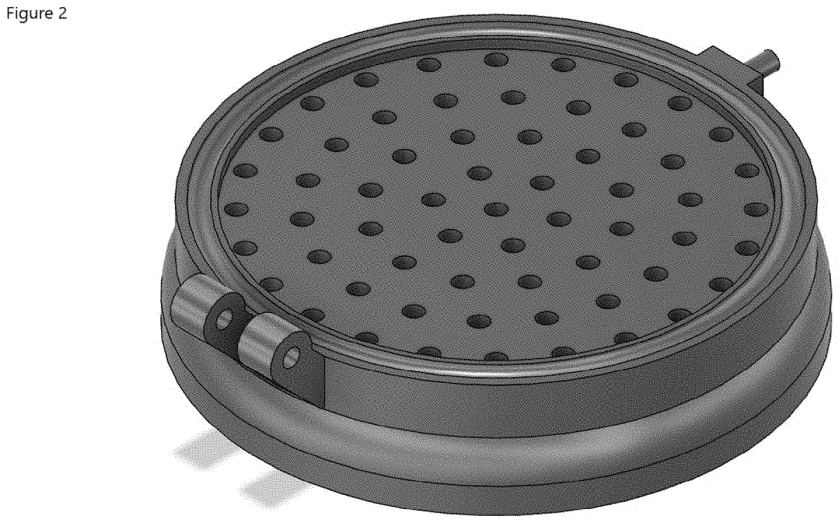

FIG. 2 is a diagram showing a strainer lid that is used to keep produce enclosed inside of the container as the fruit is washed and as the liquid and the cleaning solution if used is poured out of the container. After the produce, the liquid, and/or cleaner are placed in the container the strainer lid is screwed on to the top of the container.

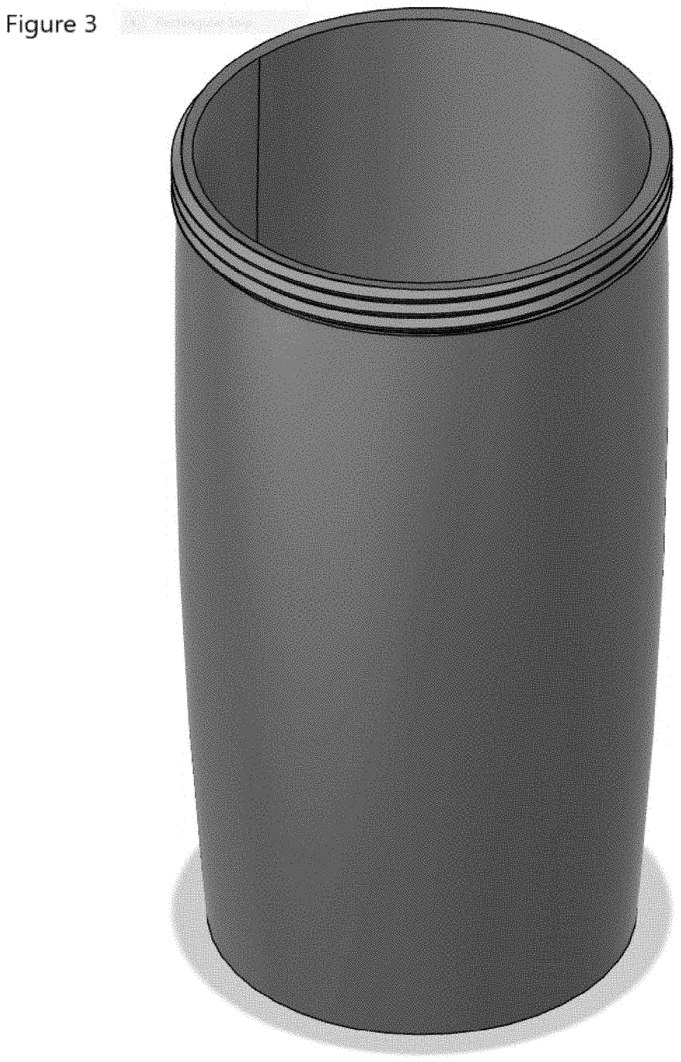

FIG. 3 is a diagram showing a container that is used to hold liquids, the cleaning solution, and produce. The produce is placed in the container and filled with water. The cleaning solution may or may not be added to the water. Once the cleaning solution is added to the water, if it is used, the dual lid system is screwed onto the container to prevent liquid from escaping. The container is shaken or tilted several times to clean the produce. After cleaning the produce, the water is poured out of the container through the strainer lid and the produce is removed. The container may be placed in a cup holder.

What is claimed is:

1. An apparatus comprising:
a dual lid system configured to couple with a cylindrical container, the dual lid comprising a first lid that is a cover containing a rectangular slot and the second lid is a strainer, wherein the first lid coupled to the second lid covers the second lid when both are closed, and the second lid includes a plurality of holes, coupled to a cylindrical container with an opening configured to allow fruit or vegetables to enter the container.

2. The apparatus of claim 1, wherein the slot holds the cleaner package.

3. The apparatus of claim 1, wherein the outer top lid, is made of a solid plastic material which holds the liquids within the cup.

4. The apparatus of claim 1, wherein at least one of the plurality of recess holes has at least one of a different size or a different shape than at least one the plurality of holes.

5. The apparatus of claim 1, wherein the recess comprises a tapered cylindrical shape.

6. An apparatus comprising:
a container and a dual lid system coupled with a cylindrical container comprising:
a container, a dual lid comprising a first lid that is a cover containing a rectangular slot along with a locking mechanism and the second lid is a strainer, wherein the first lid coupled to the second lid covers the second lid when both are closed, and the second lid includes a plurality of holes, coupled to a cylindrical container with an opening configured to allow fruit or vegetables to enter the container.

7. The apparatus of claim 5, wherein the cover is screwed onto the body.

8. The apparatus of claim 5, further including a locking mechanism holding the cover in the closed position and operable to permit transition of the cover from the closed position to the open position.

9. The apparatus of claim 5, wherein the bottom of the container fits securely within a standard vehicle cup holder.
